(19) United States
(12) Patent Application Publication
(10) Pub. No.: US 2025/0021609 A1
(43) Pub. Date: Jan. 16, 2025

(54) SYSTEM AND METHOD OF FULLY AUTOMATED CLIENT SERVER ARCHITECTURE

(71) Applicant: SHINYDOCS CORPORATION, Kitchener (CA)

(72) Inventors: Jason William David CASSIDY, Kitchener (CA); Khalid MERHI, Kitchener (CA); Peter VANLEEUWEN, Guelph (CA); Ben BARTH, Waterloo (CA); Robert HASKETT, Kitchener (CA); Cristina NEMES, Stratford (CA); Craig TREULIEB, Kitchener (CA); Nick WHITNEY, Kitchener (CA); Matt ELLIG, Kitchener (CA)

(21) Appl. No.: 18/769,555

(22) Filed: Jul. 11, 2024

Related U.S. Application Data
(60) Provisional application No. 63/512,917, filed on Jul. 11, 2023.

(51) Int. Cl. G06F 16/951; G06F 16/958

(52) U.S. Cl. CPC G06F 16/951; G06F 16/958

(57) ABSTRACT

A system and method of an automated client server architecture for describing, controlling, and executing a collection of “tools” that can be collectively used to automatically create or update an Index (via crawling) and then automatically enriching that Index (via various enhancement tools) while requiring minimal human intervention. Agents (Clients) can announce their availability to Control Center (server) for authentication and units of work. The Control Center coordinates and distributes work to authenticated Agents, including the software to perform the work, as required. This disclosure seeks to resolve the issue of enabling a suite of tools to be implemented and executed on a host file share, ECM and other non-ECM content stores in such a manner that minimizes the requirement for human intervention while also minimizing any impact to system or network performance for end users, while facilitating the benefits of these processes in a timely and effective manner.

### CROSS REFERENCE TO RELATED APPLICATION

The application claims priority and the benefit of U.S. Provisional Patent Application Ser. No. 63/512,917, entitled “SYSTEM AND METHOD OF FULLY AUTOMATED CLIENT SERVER ARCHITECTURE”, filed on Jul. 11, 2023, the disclosure of which is incorporated herein by reference in its entirety.

### FIELD

This disclosure relates to computer systems and, more specifically, to the automated crawling, extraction, and enrichment of text from contents in these systems, requiring minimal human intervention.

### BACKGROUND

Enterprise file shares or enterprise content management (ECM) systems are often used to store files and other data for access by users of an organization's computers.

Shinydocs had previously developed a number of software tools that were designed to be run independently of each other, many of them via a Windows command line interface. There were a number of installation, configuration and execution steps that were performed by humans, who leveraged their knowledge of the technology in order to properly guide the installation and execution of the suite of Shinydocs products.

It was clear that this approach, while successful to-date for a small company—or for a small installation—would not scale effectively for use by hundreds (or thousands) of customers in dozens of highly different technical environments without the introduction of significant automation. Many of the existing tools must be run and then re-run at regular intervals in order to ensure an effective and beneficial experience by the users.

Some of the processes related to the tools require intensive computing resources to perform their assigned tasks. Depending on the contents and characteristics of the content volume, certain processes, such as a File System Crawl action, could take several hours, days, or even weeks to complete. During this time, any computing resources dedicated to those jobs will be running at an elevated level. This introduces a risk to the systems and networks in which the File System is being crawled, as the crawler may affect the responsiveness or expected availability of that File System during the crawl process. This issue is compounded by the need to run the processes for other tools in order to keep the entire system functions current.

Further complicating the problem, a searchable content index must be updated regularly in order to remain current and to maximize effectiveness. This means that operations to update the search index may be running at frequent intervals approaching continuous operation, depending on the needs of the organization. These actions could require dedicated computing resources to process these indexing and related operations.

The scheduling of these updates, when done manually, ranged from ad hoc (immediate) to hourly, daily, weekly, or monthly depending on the process involved. Further, some processes had dependencies on the successful execution/completion of previous processes (such as entity extraction, which depends on successful text extraction being done first).

Overall, there is a desire to provide automation such that when computing-intensive processes are executed on a host file share, any significant adverse impact to systems or network performance is minimized or eliminated.

### SUMMARY

A system and method of an automated client server architecture for describing, controlling, and executing a collection of “tools” that can be collectively used to automatically create or update an Index (via crawling) and then automatically enriching that Index (via various enhancement tools) while requiring minimal human intervention. Agents (Clients) can announce their availability to the Control Center (server) for authentication and units of work. The Control Center (server) coordinates and distributes work to authenticated Agents (clients), including the software to perform the work, as required. This disclosure seeks to resolve the issue of enabling a suite of tools to be implemented and executed on a host file share, Enterprise Content Management (ECM) and other non-ECM content stores in such a manner that minimizes the requirement for human intervention while also minimizing any impact to system or network performance for end users, while still facilitating the benefits of these processes in a timely and effective manner.

### BRIEF DESCRIPTION OF THE DRAWINGS

The drawings illustrate, by way of example only, embodiments of the present disclosure.

FIG. 1 is a block diagram of a networked computer system.

FIG. 2 is a block diagram of a user computer device.

FIG. 3 is a block diagram of an exemplary network architecture.

FIG. 4 is a block diagram illustrating interaction between the Control Center (Server) and Agents (Clients).

### DETAILED DESCRIPTION

This disclosure concerns exposing remote file shares or a remote content management system to a server running Shinydocs Pro. Shinydocs Pro is an analytics engine. Information will be transferred from the remote file shares or remote content management system to the Agents, which will then be embellished using various automated methods to assign attributes to each of these documents (in the Agents). Upon completion, these attributes can be searched in the analytics engine.

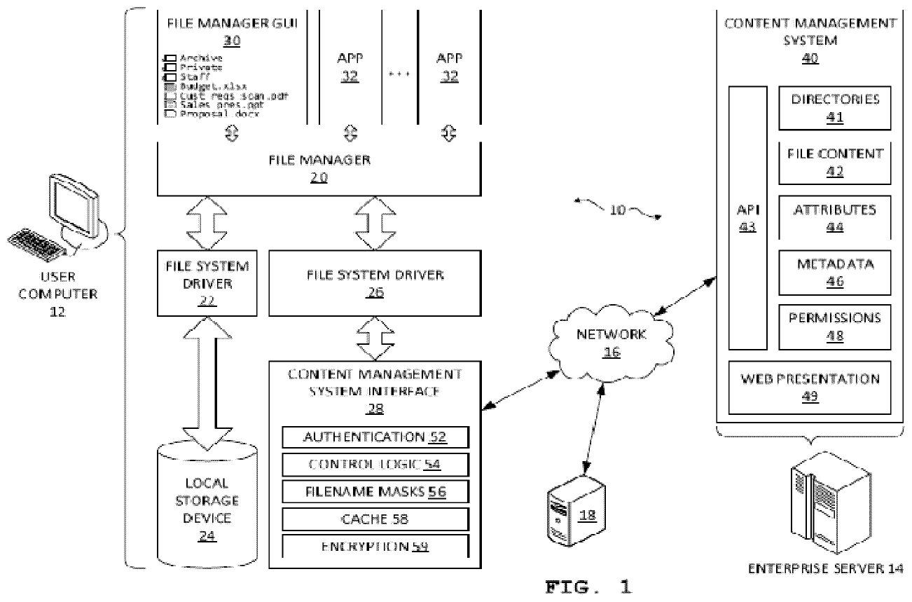

FIG. 1 shows a typical networked computer system 10 according to the present invention. The system 10 includes at least one user computer device 12 and at least one server 14 connected by a network 16.

The user computer device 12 can be any computing device such as a desktop or notebook computer, a smartphone, tablet computer, and the like. The user computer device 12 may be referred to as a computer.

The server 14 is a device such as a mainframe computer, blade server, rack server, cloud server, or the like. The server 14 may be operated by a company, government, or other organization and may be referred to as an enterprise server or an enterprise content management (ECM) system.

The network 16 can include any combination of wired and/or wireless networks, such as a private network, a public network, the Internet, an intranet, a mobile operator's network, a local-area network, a virtual-private network (VPN), and similar. The network 16 operates to communicatively couple the computer device 12 and the server 14.

In a contemplated implementation, a multitude of computer devices 12 connect to several servers 14 via an organization's internal network 16. In such a scenario, the servers 14 store documents and other content in a manner that allows collaboration between users of the computer devices 12, while controlling access to and retention of the content. Such an implementation allows large, and often geographically diverse, organizations function. Document versioning or/and retention may be required by some organizations to meet legal or other requirements.

The system 10 may further include one or more support servers 18 connected to the network 16 to provide support services to the user computer device 12. Examples of support services include storage of configuration files, authentication, and similar. The support server 18 can be within a domain controlled by the organization that controls the servers 14 or it can be controlled by a different entity.

The computer device 12 executes a file manager 20, a local-storage file system driver 22, a local storage device 24, a remote-storage file system driver 26, and a content management system interface 28.

The file manager 20 is configured for receiving user file commands from a user interface (e.g., mouse, keyboard, touch screen, etc.) and outputting user file information via the user interface (e.g., display). The file manager 20 may include a graphical user interface (GUI) 30 to allow a user of the computer 12 to navigate and manipulate hierarchies of folders and files, such as those residing on the local storage device 24. Examples of such include Windows Explorer and Mac OS Finder. The file manager 20 may further include an application programming interface (API) exposed to one or more applications 32 executed on the computer 12 to allow such applications 32 to issue commands to read and write files and folders. Generally, user file commands include any user action (e.g., user saves a document) or automatic action (e.g., application's auto-save feature) performed via the file manager GUI 30 or application 32 that results in access to a file. The file manager GUI 30 and API may be provided by separate programs or processes. For the purposes of this disclosure, the file manager 20 can be considered to be one or more processes and/or programs that provide one or both of the file manager GUI 30 and the API.

The local-storage file system driver 22 is resident on the computer 12 and provides for access to the local storage device. The file system driver 22 responds to user file commands, such as create, open, read, write, and close, to perform such actions on files and folders stored on the local storage device 24. The file system driver 22 may further provide information about files and folders stored on the local storage device 24 in response to requests for such information.

The local storage device 24 can include one or more devices such as magnetic hard disk drive, optical drives, solid-state memory (e.g., flash memory), and similar.

The remote-storage file system driver 26 is coupled to the file manager 20 and is further coupled to the content management system interface 28. The file system driver 26 maps the content management system interface 28 as a local drive for access by the file manager 20. For example, the file system driver 26 may assign a drive letter (e.g., “H:”) or mount point (e.g., “/Enterprise”) to the content management system interface 28. The file system driver 26 is configured to receive user file commands from the file manager 20 and output user file information to the file manager 20. Examples of user file commands include create, open, read, write, and close, and examples of file information include file content, attributes, metadata, and permissions.

The remote-storage file system driver 26 can be based on a user-mode file system driver. The remote-storage file system driver 26 can be configured to delegate callback commands to the content management system interface 28. The callback commands can include file system commands such as Open, Close, Cleanup, CreateDirectory, OpenDirectory, Read, Write, Flush, GetFileInformation, GetAttributes, FindFiles, SetEndOfFile, SetAttributes, GetFileTime, SetFileTime, LockFile, UnLockFile, GetDiskFreeSpace, GetFileSecurity, and SetFileSecurity.

The content management system interface 28 is the interface between the computer 12 and the enterprise server 14. The content management system interface 28 connects, via the network 16, to a content management system 40 hosted on the enterprise server 14. As will be discussed later in this document, the content management system interface 28 can be configured to translate user commands received from the driver 26 into content management commands for the remote content management system 40.

The content management system interface 28 is a user-mode application that is configured to receive user file commands from the file manager 20, via the driver 26, and translate the user file commands into content management commands for sending to the remote content management system 40. The content management system interface 28 is further configured to receive remote file information from the remote content management system 40 and to translate the remote file information into user file information for providing to the file manager 20 via the driver 26.

The remote content management system 40 can be configured to expose an API 43 to the content management system interface 28 in order to exchange commands, content, and other information with the content management system interface 28. The remote content management system 40 stores directory structures 41 containing files in the form of file content 42, attributes 44, metadata 46, and permissions 48. File content 42 may include information according to one or more file formats (e.g., “.docx”, “.txt”, “.dxf”, etc.), executable instructions (e.g., an “.exe” file), or similar. File attributes 44 can include settings such as hidden, read-only, and similar. Metadata 46 can include information such as author, date created, date modified, tags, file size, and similar. Permissions 48 can associate user or group identities to specific commands permitted (or restricted) for specific files, such as read, write, delete, and similar.

The remote content management system 40 can further include a web presentation module 49 configured to output one or more web pages for accessing and modifying directory structures 41, file content 42, attributes 44, metadata 46, and permissions 48. Such web pages may be accessible using a computer's web browser via the network 16.

The content management system interface 28 provides functionality that can be implemented as one or more programs or other executable elements. The functionality will be described in terms of distinct elements, but this is not to be taken as limiting or exhaustive. In specific implementations, not all of the functionality need be implemented.

The content management system interface 28 includes an authentication component 52 that is configured to prompt a user to provide credentials for access to the content management system interface 28 and for access to the remote content management system 40. Authentication may be implemented as a username and password combination, a certificate, or similar, and may include querying the enterprise server 14 or the support server 18. Once the user of the computer device 12 is authenticated, they may access the other functionality of the content management system interface 28.

The content management system interface 28 includes control logic 54 configured to transfer file content between the computer 12 and the server 14, apply filename masks, evaluate file permissions and restrict access to files, modify file attributes and metadata, and control the general operation of the content management system interface 28. The control logic 54 further effects mapping of remote paths located at the remote content management system 40 to local paths presentable at the file manager 20. Path mapping permits the user to select a file via the final manager 20 and have file information and/or content delivered from the remote content management system 40. In one example, the remote files and directories are based on a root path of “hostname/directory/subdirectory” that is mapped to a local drive letter or mount point and directory (e.g., “H:/hostname/directory/subdirectory”).

The content management system interface 28 includes filename masks 56 that discriminate between files that are to remain local to the computer 12 and files that are to be transferred to the remote content management system 40. Temporary files may remain local, while master files that are based on such temporary files may be sent to the remote content management system 40. This advantageously prevents the transmission of temporary files to the remote content management system 40, thereby saving network bandwidth and avoiding data integrity issues (e.g., uncertainty and clutter) at the remote content management system 40.

The content management system interface 28 includes a cache 58 of temporary files, which may include working versions of files undergoing editing at the user computer device 12 or temporary files generated during a save or other operating of an application 32.

The content management system interface 28 includes an encryption engine 59 configured to encrypt at least the cache 58. The encryption engine 59 can be controlled by the authentication component 52, such that a log-out or time out triggers encryption of the cache 58 and successful authentication triggers decryption of the cache 58. Other informational components of the content management system interface 28 may be encrypted as well, such as the filename masks 56. The encryption engine 59 may conform to an Advanced Encryption Standard (AES) or similar.

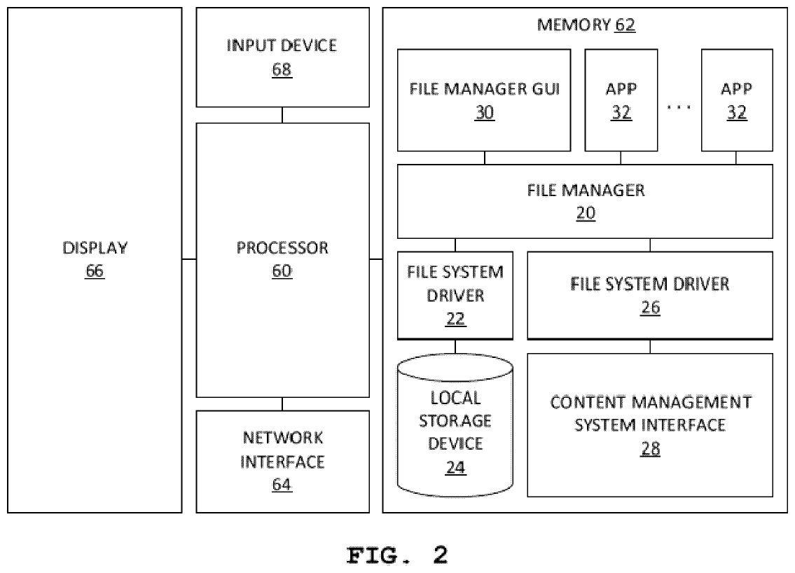

FIG. 2 shows an example of a user computer device 12. The computer device 12 includes a processor 60, memory 62, a network interface 64, a display 66, and an input device 68. The processor 60, memory 62, network interface 64, display 66, and input device 68 are electrically interconnected and can be physically contained within a housing or frame.

The processor 60 is configured to execute instructions, which may originate from the memory 62 or the network interface 64. The processor 60 may be known a CPU. The processor 60 can include one or more processors or processing cores.

The memory 62 includes a non-transitory computer-readable medium that is configured to store programs and data. The memory 62 can include one or more short-term or long-term storage devices, such as a solid-state memory chip (e.g., DRAM, ROM, non-volatile flash memory), a hard drive, an optical storage disc, and similar. The memory 62 can include fixed components that are not physically removable from the client computer (e.g., fixed hard drives) as well as removable components (e.g., removable memory cards). The memory 62 allows for random access, in that programs and data may be both read and written.

The network interface 64 is configured to allow the user computer device 12 to communicate with the network 16 (FIG. 1). The network interface 64 can include one or more of a wired and wireless network adaptor and well as a software or firmware driver for controlling such adaptor.

The display 66 and input device 68 form a user interface that may collectively include a monitor, a screen, a keyboard, keypad, mouse, touch-sensitive element of a touch-screen display, or similar device.

The memory 62 stores the file manager 20, the file system driver 26, and the content management system interface 28, as well as other components discussed with respect to FIG. 1. Various components or portions thereof may be stored remotely, such as at a server. However, for purposes of this description, the various components are locally stored at the computer device 12. Specifically, it may be advantageous to store and execute the file manager 20, the file system driver 26, and the content management system interface 28 at the user computer device 12, in that a user may work offline when not connected to the network 16. In addition, reduced latency may be achieved. Moreover, the user may benefit from the familiar user experience of the local file manager 20, as opposed to a remote interface or an interface that attempts to mimic a file manager.

This disclosure seeks to resolve the issue of enabling the suite of Shinydocs tools to be implemented and executed on a host file share in such a manner that minimizes, or eliminates, any impact to system or network performance to the end users, while still facilitating the benefits of these processes in a timely and effective manner.

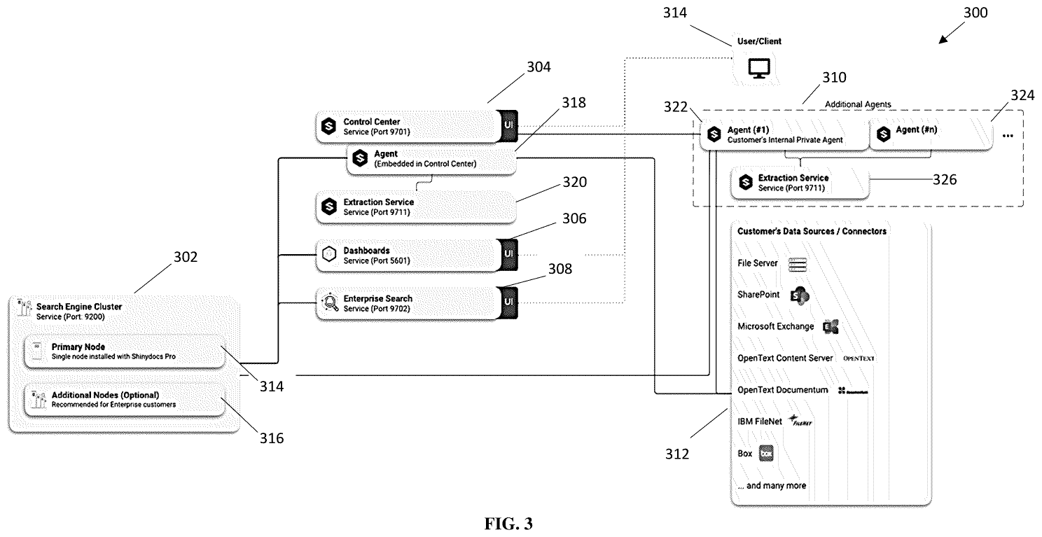

FIG. 3 is a block diagram of an exemplary network architecture. According to FIG. 3, system 300 comprises a Search Engine Cluster 302, a Control Center module 304, a Dashboards module 306, an Enterprise Search module 308, an Agent module 310 and a Connectors module 312. The Control Center module 304, a Dashboards module 306 and an Enterprise Search module 308 connects to one or more users or clients 314.

According to FIG. 3, the Search Engine Cluster module 302 operates services from port 9200 and further comprises a Primary Node 314 and Additional Nodes 316. The Primary Node 314 is a single node installed with Shinydocs Pro. The Additional Nodes 316 is an optional extension that is recommended for enterprise customers.

According to FIG. 3, the Control Center module 304 operate services from port 9701 and further comprises up to one Agent module 318 that are embedded in the Control Center. Agent module 318 also interacts with the Extraction Service module 320 at port 9711. The Control Center module 304 also interacts with optional additional remote Agent modules 310 that may be considered a client or customer's internal private Agent. Additional Agent module 310 further comprises of a one additional agent 322 and up to N additional agents 324. Additional Agent module 310 further connects to Additional Extraction Service module 362 that operate services from port 9711.

According to FIG. 3, the Dashboards module 306 further comprises a user interface (UI) or graphical user interface (GUI) and operates services from port 5601. Furthermore, the Enterprise search module 308 also includes a UI or GUI and operates services from port 9702.

According to FIG. 3, the Connectors module 312 provides connections to the customer's data sources and may include connectors for File Server, Microsoft 365, OpenText Content Server, OpenText Documentum, IBM FileNet, Box and other similar applications.

According to FIG. 3, benefits of this system architecture 300 are achieved via the use of one or more Agent processing nodes 310 or 318 that are coordinated by a Control Center module 304, as in a distributed computing system. The Control Center module 304 administration can manage a scalable number of Agent modules 310 to accomplish the desired processing jobs. The Control Center service 304 may include license and product management, source management, Agent management and extraction service management.

The Agent modules 318 or 310 may be engaged or idled as needed, depending on the requirements of the processing job. Key to this is the determination of the requirements of the processing job, and the subsequent scheduling of Agent nodes to perform those jobs. The Agent modules 318 or 310 are managed through the Control Center module 304 and provide the ability to download extraction services, update versions of connectors, crawl, enrich and action/remediate data in source repositores.

According to FIG. 3, Extraction Service modules 320 and 322 can be found within the Agent Modules 318 and 310 and is responsible for extracting text from files and content. Including utilizing optical character recognition (OCR) for images or portable document format (PDF).

Scheduling is done immediately (typically when a new Agent 318 or 310 is assigned)—or is assigned as hourly, daily, weekly, or even monthly, depending on the requirements of the Agent process involved. Further, if it is required that a sequence of specific Agent processes need to be followed, the Control Center service 304 will manage that requirement.

The Control Center module 304 is able to not only manage and schedule existing Agents 318 and 310 but is also able to augment the ability of Agents by providing the Agent with the necessary software to perform the assigned job, should the Agent require it.

However, in this arrangement, the Agent modules 318 and 310 have a much bigger role than in traditional distributed computing configurations. In this architecture, the Agent machines will request jobs from the Control Center, based on the availability of computing resources on the Agent machine. All job requests originate from the Agent and are provided based upon availability from the Control Center. As a result, any authentication requests must similarly come from the Agent and must be validated by the Control Center in order to secure the job transaction.

This architecture enables the Agents 310 to exist in a different network domain than the Control Center. As an example, an intended configuration of this would be to have the Control Center exist in the cloud, but have the Agents located within a client's on-premise network, either as dedicated hardware or virtual machines. This gives the Agents host (the client) more control over the number of computing nodes that can be dedicated to the associated tasks to maintain their Shinydocs application.

According to FIG. 3, there are three main components of this solution, which are as follows:

### Control Center/Orchestrator

The Control Center/orchestrator 304 is responsible for resolving any dependencies, requirements, or other necessities to deliver appropriate Work Units to Agents.

### Agents

The Agents 318 or 310 are responsible for requesting Work Units from the Control Center and executing it with the appropriate Extraction Service module 320 or 326. It is important that the Agent contains as little logic as possible. The Agent modules 318, 310, 322 or 324 are configured from the Control Center 304 such as how many Work Units to run simultaneously.

### Agent Registration

Agents are able to contact the Control Center 304, but the Control Center 304 does not have to be able to contact an Agent directly. This means Agents need to be the ones that request registration. The Agents will request registration via gRPC and wait for a response.

The registration request will contain enough identifiable information for a Control Center administrator to trust an Agent. Once trusted, the Agent will receive a response.

A trusted registration response will contain a key. From that point on, the Agent must send this key with every API call to prove identity and trust. Agents connecting through a non-trusted or public network should communicate using SSL/TLS. If the key becomes compromised, an administrator is able to revoke the key and generate a new one.

According to the disclosure, a simplified method and system to automatically and seamlessly connect Agents that request (and receive) generic “Work Units,” and Agents that can update their tools and tooling to accomplish the work units is disclosed.

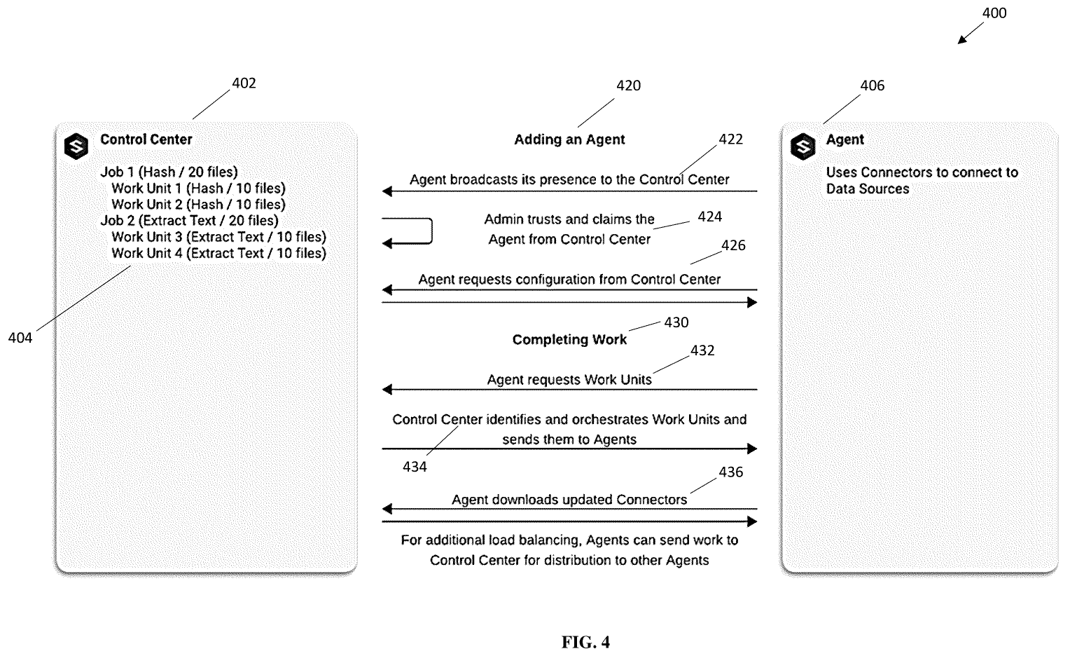

FIG. 4 is a block diagram illustrating interaction between the Control Center and an Agent. According to FIG. 4, block diagram 400 includes Control Center 402 with multiple jobs 404 and an Agent module 406.

According to FIG. 4, the process to add an agent 420 includes the steps of Agent broadcasts, which announces its presence to the Control Center at step 422. After authentication, the Control Center recognizes the Agent as a trusted resource 424 by the Control Center and sends configuration information to the Agent from the Control Center at step 426.

According to FIG. 4, the process for completing work 430 includes the steps of the Agent requesting work units at step 432 which can be assigned based on the number of parallel processes the Agent is available to do or to perform. Thereafter, the Control Center identifies the work units and sends them to the Agent at step 434. The work units include instructions to execute as well as what extraction service (and exact version) to execute them on. If the Agent does not have the appropriate extraction service (Shinydocs Pro tool), it will download the extraction service and install it from the Control Center at step 436 and then proceed with the assigned work unit.

According to the disclosure, disclosed herein is a system and for describing, controlling and executing a collection of “tools” that can be collectively used to automatically create an Index (via crawling) and then automatically enrich that Index (via various enhancement tools such as Add Hash, Add Full Text, Identify ROT and Classify) requiring minimal human intervention. As more throughput is needed, additional machines will be spun up and imaged (and then used) automatically.

According to the disclosure, a system for controlling and executing one or more tools for creating and enriching an index using an automated client server architecture is disclosed. The system comprises a computer processor, a Control Center module configured for distributed computing service administration and management, a plurality of Agent modules configured for completing processing tasks, a discovery and search enrichment module configured for managing connections, a data analytics and search module configured for searches, an external connections module configured for managing external connections and an external integration and export module configured for managing external integration services.

According to the disclosure, the Control Center module is configured to manage the plurality of Agents, the discovery search and enrichment module, the external connections module and the external integration and export module and instruct the Agent modules to execute and process tasks. The Agents are configured to download extraction services and manage connections and the steps of creating and enriching the index is accomplished requiring minimal human intervention.

According to the disclosure, the system is further configured to automatically create the index via crawling and then automatically enriching the index via various enhancement tools such as Add Hash, Add Full Text, Identify ROT and Classify. The Control Center is further configured for license & product management, source management, Agent management, extraction service management. The extraction service manages connections including Shinydocs supported connections and 3rd party connections.

According to the disclosure, the external connections of the system include cloud infrastructure, a data store, a file system, an in-place database and/or a content management system (CMS). The services for External Integration Export module of the system includes Opensearch dashboards and ODBC connections.

According to the disclosure, the Agents of the system can announce their availability to the Control Center for authentication and units of work. Tor additional load balancing, the Agents will send extra work to the Control Center to distribute to other Agents.

According to the disclosure, the Control Center of the system coordinates and distributes work to authenticated Agents, including the software to perform the work, as required. The system further comprises tools to be implemented and executed on a host file share or virtual machine (VM) that minimizes the requirement for human intervention and minimizing impact to system or network performance for end users.

According to the disclosure, a computer-implemented method for adding a client Agent to a Control Center server in an automated client server architecture is disclosed. The method comprising the steps of broadcasting the presence of the client Agent to the Control Center server, authenticating the client Agent with the Control Center server, after authentication, recognizing the client Agent as a trusted resource and sending configuration information to the client Agent from the Control Center server.

According to the disclosure, the client Agents of the method are configured to execute the tasks assigned by the Control Center server. The method further comprises the step of administering trusts and claims client Agent from the Control Center server.

According to the disclosure, a computer-implemented method for completing work or executing a task by a client Agent in an automated client server architecture is disclosed. The method comprising the steps of receiving instructions from the client Agent requests work units from a Control Center server, receiving instructions from the Control Center server identifies the work units and sends to client Agent and downloading an extraction service to complete the work unit at the client Agent.

According to the disclosure, the work units of the method are assigned based on the number of parallel processes the Agent is configured to perform or process. The work units of the method include instructions to execute a toolkit or an extraction service.

Implementations disclosed herein provide systems, methods, and apparatus for autonomously generating, augmenting, or updating a content index derived from a defined network file source. The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code, or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A system for controlling and executing one or more tools for creating and enriching an index, using an automated client server architecture, the system comprising:
a computer processor;
a Control Center module configured for distributed computing service administration and management;
a plurality of Agent modules configured for completing processing tasks;
a discovery and search enrichment module configured for managing connections;
a data analytics and search module configured for searches;
an external connections module configured for managing external connections; and
an external integration and export module configured for managing external integration services;
wherein the Control Center module is configured to manage the plurality of Agents, the discovery search and enrichment module, the external connections module and the external integration and export module and instruct the Agent modules to execute and process tasks;
wherein the Agents are configured to download extraction services and manage connections;
wherein the steps of creating and enriching the index is accomplished requiring minimal human intervention.

2. The system of claim 1 is further configured to automatically create the index via crawling and then automatically enriching the index via various enhancement tools such as Add Hash, Add Full Text, Identify ROT and Classify.

3. The system of claim 1 wherein the Control Center is further configured for license & product management, source management, Agent management, extraction service management.

4. The system of claim 1 wherein the extraction service manages connections including Shinydocs supported connections and 3^{rd} party connections.

5. The system of claim 1 wherein the external connections include cloud infrastructure, a data store, a file system, an in-place database and/or a content management system (CMS).

6. The system of claim 1 wherein the services for External Integration Export module includes Opensearch dashboards and ODBC connections.

7. The system of claim 1 wherein the Agents can announce their availability to the Control Center for authentication and units of work.

8. The system of claim 7 wherein for additional load balancing, the Agents will send extra work to the Control Center to distribute to other Agents.

9. The system of claim 1 wherein the Control Center coordinates and distributes work to authenticated Agents, including the software to perform the work, as required.

10. The system of claim 1 further comprises tools to be implemented and executed on a host file share or virtual machine (VM) that minimizes the requirement for human intervention and minimizing impact to system or network performance for end users.

11. A computer-implemented method for adding a client Agent to a Control Center server in an automated client server architecture, the method comprising the steps of:
broadcasting the presence of the client Agent to the Control Center server;
authenticating the client Agent with the Control Center server;
after authentication, recognizing the client Agent as a trusted resource; and
sending configuration information to the client Agent from the Control Center server;
wherein the client Agents are configured to execute the tasks assigned by the Control Center server.

12. The method of claim 11 further comprises the step of administering trusts and claims client Agent from the Control Center server.

13. A computer-implemented method for completing work or executing a task by a client Agent, in an automated client server architecture, the method comprising the steps of:
receiving instructions from the client Agent requests work units from a Control Center server;
receiving instructions from the Control Center server identifies the work units and sends to client Agent; and
downloading an extraction service to complete the work unit at the client Agent.

14. The method of claim 13 wherein the work units are assigned based on the number of parallel processes the Agent is configured to perform or process.

15. The method of claim 13 wherein the work units include instructions to execute a toolkit or an extraction service.
